(19) United States
(12) Patent Application Publication
(10) Pub. No.: US 2008/0210104 A1
(43) Pub. Date: Sep. 4, 2008

(54) Meat Processing Machine Comprising a Fat Analyzing Device

(75) Inventors: Stefan Josef Linn, Runkel (DE); Hartmut Hoffmann, Bad Laasphe-Feudingen (DE); Dieter Evers, Straubenhardt (DE)

Correspondence Address: FOLEY & LARDNER LLP, 777 EAST WISCONSIN AVENUE, MILWAUKEE, WI, 53202-5306, US

(73) Assignee: CFS Germany GmbH

(21) Appl. No.: 10/592,847

(22) PCT Filed: Feb. 1, 2005
(86) PCT No.: PCT/EP2005/000949

§ 371 Date: Apr. 23, 2008

(30) Foreign Application Priority Data
Mar. 17, 2004 (DE) 102004013339.5
Jun. 2, 2004 (DE) 102004027024.4

(51) Int. Cl. B26D 1/00

(52) U.S. Cl. 99/537

(57) ABSTRACT

The invention relates to a meat processing machine, with the aid of which fresh and/or frozen meat is chopped and which comprises a fat analyzing device for determining the fat content in the meat.

The present invention relates to a meat processing machine with which fresh and/or frozen meat is chopped and which has a fat analyzing device for determining the fat content, the density in the meat and/or the meat albumin free from connective-tissue protein.

Since nowadays meat products must not exceed a certain fat content, a precise fat analysis of meat and an exact setting of certain fat contents in meat products are of increasing importance. The analysis of the fat content of the meat preferably takes place during the processing in a meat processing machine. There is therefore a series of proposals as to how these measurements should take place but they all have the disadvantage of being very complicated and/or of sometimes being imprecise.

It is therefore the object to provide a meat chopping machine which has a fat analyzing device with which the fat content of fresh or frozen meat can be determined with sufficient precision.

The object is achieved with a meat chopping machine according to patent claim 1. Preferred embodiments of the meat chopping machine are claimed in subclaims 2 to 5.

It was entirely surprising and not to be anticipated by a person skilled in the art that it was possible with the meat chopping machine according to the invention to very precisely determine the fat content of the meat product to be processed. With the device according to the invention, it is possible to reduce measuring errors which arise due to structural problems in the product to be measured. In particular, the rough chopping and/or mixing of the product to be analyzed considerably reduces the measuring errors.

Any fat analyzing means customary to a person skilled in the art is suitable as the fat analyzing means. However, the fat analyzing means preferably has a radiation source with preferably a plurality of energy stages and a radiation detector. In a very particularly preferred embodiment, the radiation source is an X-ray source and the radiation detector is an X-ray detector. An infrared source as radiation source and an infrared detector as radiation detector are likewise preferred.

In the case of the fat analysis by means of an X-ray detector, the weakening of the X rays preferably is measured in an energy range of between 18 and 45 keV. The measuring path, in particular the meat layer through which the radiation penetrates, is preferably 20 to 300 mm, particularly preferably 50 to 100 mm, very particularly preferably 50-70 mm. The calculation of the fat content and the controlling of the X ray source take place by means of a microprocessor or stored program control (SPC control).

The fat analysis likewise preferably takes place with near infrared reflection (NIR) or with near infrared transmission (NIT).

According to the invention, a chopping means is provided upstream, with respect to the flow direction of the meat, of the fat analyzing device. This chopping means is preferably a rough cutter. Preferably, furthermore, the means is a perforated disk which particularly preferably interacts with a blade. In another preferred embodiment, the chopping means is a blade. The meat to be analyzed is chopped and preferably mixed in the rough cutter or in the perforated disk and/or the blade. The chopping means may also be used in combination.

Meat within the meaning of the invention is any product which at least partially contains meat.

The fat analyzing device is preferably arranged in a measuring rough cutter which is arranged behind the rough cutter, with respect to the flow direction of the meat. This measuring rough cutter has recesses at the edges of which the meat is preferably not chopped further after the rough chopping in the rough cutter. The measuring section of the fat analyzing device is preferably arranged in one of these recesses. The additional rough cutter upstream of the measuring rough cutter has the advantage that the wear takes place at the rough cutter and is at least reduced at the measuring rough cutter, and therefore the defined fit of the fat analyzing device in the measuring rough cutter is not changed. The accuracy of the fat analysis is increased by the rough chopping of the product in the rough cutter.

Chopping and/or mixing of the product to be analyzed before the measurement also in particular has the advantage that two partial strands, which are offset in relation to each other, enter the measuring chamber and therefore erroneous measurements due to unfavorable fat/lean layerings are avoided.

Very particularly preferably, the recesses of the rough cutter, in particular the recess which is mounted upstream of the measuring section of the fat analyzing device, is divided at least once, for example, by means of a web. This embodiment has the advantage that the product to be analyzed is divided in the rough cutter and, when subsequently brought together in the measuring rough cutter, is mixed once again, which leads to substantially more representative measurement results. Furthermore, this embodiment has the advantage of preventing some of the meat from adhering in the measuring chamber for a relatively long period of time causing the measurement to be falsified.

The rough cutter preferably interacts with an additional blade which is arranged upstream of the rough cutter, with respect to the flow direction of the meat. This additional blade ensures neat cutting of the meat, with the result that, for example, no connective tissue is placed over the web of the rough cutter. This prevents meat with a random fat content from remaining in the measuring chamber for a relatively long period of time, and this likewise has a positive effect on the quality of the analysis.

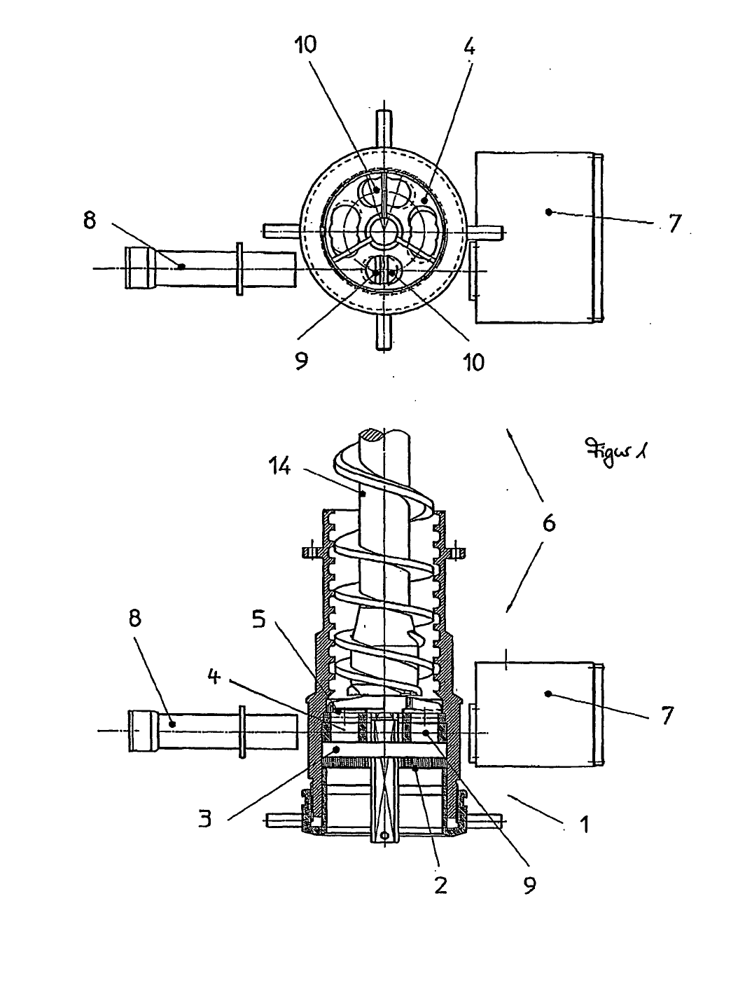

The invention is explained below with reference to FIGS. 1 to 3. These explanations are merely by way of example and do not restrict the general inventive concept.

FIG. 1 shows parts of a meat chopping machine.

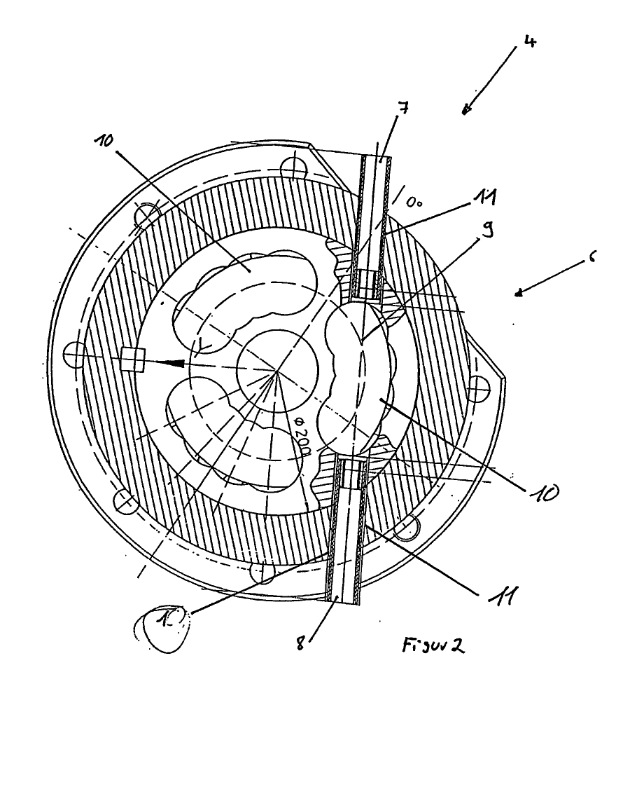

FIG. 2 shows a measuring rough cutter.

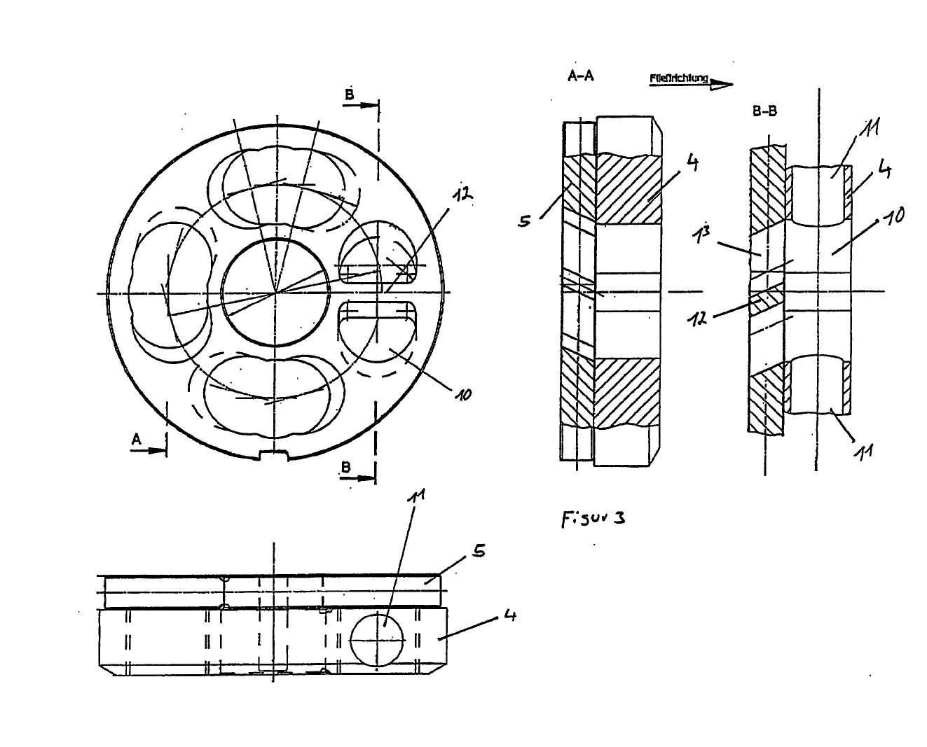

FIG. 3 shows the combination of a measuring rough cutter and the wearing rough cutter mounted upstream of it.

FIG. 1 shows an embodiment of the meat chopping machine according to the invention in two views. As is apparent from the right-hand view, the meat is transported from the left to the right by a worm 14 and is chopped in the set of cutters 1. The set of cutters 1 comprises two rough cutters, the rough cutter S and the measuring rough cutter 4, a blade 3 arranged downstream and a perforated disk 2, the blade 3 interacting with the perforated disk. A person skilled in the art will recognize that another blade can likewise be provided upstream of the rough cutter 5, which is mounted upstream of the measuring rough cutter 4. The wear which occurs during the rough chopping takes place at the rough cutter 5, thus at least greatly reducing the wear at the measuring rough cutter 4.

A fat analyzing device which comprises a radiation source 7 and a radiation detector 8 is arranged in the measuring rough cutter 4. A beam, in the present beam an X ray beam 9, is emitted by the radiation source 7 and, as is apparent from the left-hand part of FIG. 1, penetrates the recess 10 in the measuring rough cutter 4 and is received and analyzed by the radiation detector 8 at the end of the recess 10.

FIG. 2 shows a detailed illustration of the measuring rough cutter 4. Holes 11 into which the radiation source 7 and the radiation detector 8 are introduced are arranged in the region of a recess 10. The radiation source 7 emits an X ray 9 which penetrates the meat which is situated in the recess 10. Owing to the different absorption of the radiation 9 by fat and lean meat, the fat content of the meat situated in the recess can be determined.

FIG. 3 illustrates the combination of rough cutter 5 and measuring rough cutter 4. The rough cutter 5 is mounted upstream of the measuring rough cutter 4, with respect to the flow direction of the meat, the recesses 13 of the rough cutter 5 essentially overlapping the recesses 10 of the measuring rough cutter 4. A web 12 is provided in one of the recesses 13 of the rough cutter 5, which recess is mounted upstream of the measuring section, so that this recess is divided.

This division of the recess 13 has the advantage that the meat is more thoroughly mixed in the recess 10 of the measuring cutter 4, in which its fat content is determined. A blade (not illustrated) is arranged upstream of the rough cutter 5, with respect to the flow direction of the meat, the blade neatly cutting the incoming pieces of meat, so that, during the measurement, the meat pieces have already been neatly roughly chopped, which improves the quality of the measurement result. Furthermore, the division of the recess has the advantage that an unfavorable layering of the meat, which falsifies the measurement, in the measuring chamber (measuring section) is avoided.

A person skilled in the art recognizes that a simple mixing of the meat before the measurement may also be sufficient in order to avoid erroneous measurements due to unfavorable layerings of the meat in the measuring section.

### LIST OF REFERENCE NUMBERS

1 Set of cutters
2 Perforated disk
3 Blade
4 Measuring rough cutter
5 Rough cutter with a divided recess
6 Fat analysis measuring device
7 Radiation source
8 Radiation detector
9 Beam
10 Recess in the measuring rough cutter
11 Hole for radiation source and/or radiation detector
12 Web
13 Recess in the rough cutter
14 Web

1.-6. (canceled)

7. A meat chopping machine comprising:
a set of cutters; and
a fat analyzing device located in the region of the set of cutters;
wherein the set of cutters includes at least one of a rough cutter and a perforated disk located upstream with respect to the fat analyzing device and the direction of flow of a meat product to be analyzed by the fat analyzing device; and
wherein the rough cutter includes at least one recess that is divided.

8. The meat chopping machine of claim 7, further comprising:
a measuring rough cutter;
wherein the fat analyzing device is arranged in the measuring rough cutter.

9. The meat chopping machine of claim 7, wherein the rough cutter is a wearing rough cutter.

10. The meat chopping machine of claim 7, wherein the recess is divided by a web, the web configured to divide a meat product into two partial strands that run into a measuring chamber of the measuring rough cutter.

11. The meat chopping machine of claim 7, further comprising a blade that interacts with the rough cutter.
